(19) United States
(12) Patent Application Publication
(10) Pub. No.: US 2025/0333083 A1
(43) Pub. Date: Oct. 30, 2025

(54) METHOD AND DEVICE FOR COOPERATION IN THE COORDINATION OF DRIVING MANEUVERS

(71) Applicant: Continental Automotive Technologies GmbH, Hannover (DE)

(72) Inventors: Sebastian Strunck, Niedernhausen (DE); Thomas Grotendorst, Eschborn (DE); Martin Sevenich, Frankfurt am Main (DE)

(73) Assignee: Continental Automotive Technologies GmbH, Hannover (DE)

(21) Appl. No.: 19/193,372

(22) Filed: Apr. 29, 2025

(30) Foreign Application Priority Data
Apr. 29, 2024 (DE) 10 2024 203 986.1

(51) Int. Cl. B60W 60/00; B60W 30/095

(52) U.S. Cl. CPC B60W 60/0027; B60W 30/0956; B60W 2556/65

(57) ABSTRACT

Disclosed is cooperative coordination of driving maneuvers of a vehicle with foreign maneuvers of a foreign vehicle, wherein a trajectory family is generated which comprises multiple planned-ahead ego trajectories having a reference trajectory. Tuples are then formed from an ego trajectory and a foreign trajectory or an additional foreign trajectory, the tuple is assessed using a tuple effort value and collision-free tuples are determined. If the ego vehicle has the right-of-way, an egoistic and an altruistic trajectory are selected. Based on the difference between the tuple effort values of the tuple comprising the altruistic trajectory and the tuple comprising the egoistic trajectory, the egoistic trajectory is selected if the difference is greater than a limiting value, otherwise the altruistic trajectory is selected, and the selected trajectory is sent as a reference trajectory to the foreign vehicle, wherein the limiting value is increased with progressing cooperation duration.

### BRIEF DESCRIPTION OF THE DRAWINGS

FIG. 1 shows an exemplary representation of a vehicle having a device according to one exemplary embodiment, and also a foreign vehicle.

### DETAILED DESCRIPTION

The disclosure relates to a method and a device for cooperative coordination of driving maneuvers between a vehicle and at least one foreign vehicle.

There are different options for vehicles for arriving at a cooperation to solve a specific situation in traffic events and also carrying this out. Such solutions often require explicit cooperation, in which specific cooperation partners are sought out via state machines and then a bilateral coordination is performed. In contrast, implicit coordination mechanisms exist, which are fundamentally implemented via the sending of trajectories relating to the ego driving intentions. The respective receiver has to interpret himself whether he adapts his own driving planning in order to correspond to a wish of another vehicle or not.

Published application WO 2017 076 593 A1 discloses a method for decentralized coordination of driving maneuvers of motor vehicles, wherein a planned trajectory and the desired trajectory of a first motor vehicle are transmitted to another motor vehicle in the surroundings. The second motor vehicle checks the received planned trajectory and desired trajectory as to whether they collide with the ego planned trajectory, wherein the planned trajectories of the first and the second motor vehicle are free of collisions in relation to one another in this case. If an adaptation criterion is met, an adaptation of the planned trajectory of the second motor vehicle to form an adapted planned trajectory is performed, wherein the adaptation criterion is that the received desired trajectory of the first motor vehicle collides with the planned trajectory of the second motor vehicle and an overall cost function is optimized by the adaptation, wherein the overall cost function comprises at least cost functions of the first and the second motor vehicle.

Published application WO 2019 206 377 A1 describes a method for cooperative coordination of future driving maneuvers of a vehicle with foreign maneuvers of at least one foreign vehicle, wherein the method comprises the following steps: Assessing a trajectory family made up of preplanned trajectories for the vehicle each having an effort value using at least one assessment criterion; receiving a foreign data packet from the foreign vehicle, wherein a foreign trajectory family having different preplanned foreign trajectories for the foreign vehicle and a foreign effort value for each foreign trajectory are contained in the foreign data packet; combining one trajectory and one foreign trajectory in each case to form tuples and combining the respective effort value with the respective foreign effort value to form a tuple effort value of the tuple; selecting collision-free tuples, wherein tuples are selected in which the trajectory and the foreign trajectory are collision-free within a collision horizon; selecting the collision-free tuple having the lowest tuple effort value and classifying the trajectory and the associated effort value of this tuple as the reference trajectory and reference effort value; selecting trajectories having a lower effort value than the reference effort value and classifying these trajectories and associated effort values as demand trajectories and demand effort values, wherein a demand trajectory is a trajectory indicating a desire of the vehicle, using which a desired driving destination can be achieved more economically than using the reference trajectory; selecting trajectories having a higher effort value than the reference effort value and classifying these trajectories and associated effort values as alternative trajectories and alternative effort values, wherein an alternative trajectory is a trajectory indicating a cooperation offer, which the vehicle would possibly be ready to drive; and sending a data packet to the foreign vehicle, wherein a trajectory family made up of the reference trajectory and the associated reference effort value as well as at least one trajectory from a group comprising the demand trajectories and the alternative trajectories as well as the corresponding effort values are contained in the data packet.

In the typical systems, the approach is followed that tuples which contain a demand trajectory of a foreign vehicle receive an effort compensation in the effort assessment by the vehicle, due to which such tuples are preferred by the vehicle in the following effort-based selection. In this way, in particular a motivation for cooperation is created for the vehicle in order to accept an ego additional effort. As soon as this is communicated to the foreign vehicle, it will no longer send a demand trajectory, but only a reference trajectory. Therefore, in the next step the effort compensation is no longer active in the vehicle and the cooperation will become less beneficial for the vehicle itself and will therefore possibly be terminated. The foreign vehicle will therefore send demand trajectories again, which contain an effort compensation in the vehicle, due to which the cooperation appears beneficial again and prompts the vehicle toward renewed cooperation. Traffic situations can also change within a very short time, due to which changes of the effort values can also occur in successive assessment cycles, so that the cooperation is terminated and a cooperation has to be initialized again. A varying or unstable cooperation behavior therefore exists.

The object is to improve the stability of cooperative driving maneuver planning and avoid varying cooperation behavior.

Embodiments can advantageously enable future driving maneuvers of various vehicles to be coordinated in mutual agreement, so that none of the vehicles has to execute, for example, a disproportionately large steering intervention, braking intervention, and/or acceleration intervention in order to enable flowing traffic. A method used for this purpose can be carried out using a device, such as a control unit. Signals, measured values, or the like, which are provided, for example, by sensors, measuring devices, or the like, can be used and/or analyzed to carry out the method. The method can be carried out in a fully automated or semiautomated manner. An intervention of a human does not have to be excluded in this case, but does not have to be absolutely necessary.

Terms used in the scope of the description of the present disclosure are defined hereinafter:

A trajectory describes a status course (e.g., position, orientation, velocity and acceleration vectors, etc.) over time, on which a vehicle can be controlled using driving maneuvers. A trajectory is generally multidimensional, in particular two-dimensional or three-dimensional, and can extend along a driving surface to be traveled by the vehicle, for example, a road. The trajectory thus describes where the vehicle is located, has been located, or will be located at a given time. The trajectory is planned ahead at least up to a prediction horizon. For example, the prediction horizon can be determined by a sensor range of the vehicle. The prediction horizon can be velocity-dependent. Trajectories are not understood exclusively as trajectories in Euclidean space, but rather can also be trajectories in other possible spaces. One example of this is the Frenet space along the lane centers, in which a trajectory can consist of the specification of the respective lane and of the sections on the lane center over time. In this way, the trajectory bundle can be efficiently transferred into a structured traffic space, for example, but not limited to freeway with lane markings. A collision horizon can be less than or equal to the prediction horizon, and can also be velocity-dependent or also situation-dependent, for example, dependent on the traffic density.

The freedom from collisions of trajectories is given if trajectories extend from the vehicle to the collision horizon so that the vehicle and the foreign vehicle each have at least a minimum distance from one another.

The trajectory which is selected from the trajectory family in order to be actually driven along by the vehicle, or the trajectory which the vehicle currently follows and is the set point for the driving controller/driver, can be designated as the reference trajectory. Reference trajectories are fundamentally to be conflict-free, if conflicts occur, these can be resolved according to the road traffic regulations. A conflict can be resolved by the vehicle which is subordinate, the privileged vehicle can thus continue to send its conflict-afflicted trajectory.

An alternative trajectory is a trajectory which is more expensive than the reference trajectory, but which the vehicle would nonetheless be ready to travel. In this context, “possibly” means “conditionally”, i.e., for example, a consent of the driver can be requested before an alternative trajectory can become the reference trajectory. An assessment of the resulting overall situation can also take place, wherein it is checked whether the ego additional costs oppose a sufficient benefit (from the local view) in the other vehicles. Alternative trajectories can be planned so that they are conflict-free.

A demand trajectory describes a desired maneuver which the vehicle would readily drive due to lower “costs” or a lower effort, but currently cannot drive, for example, because the required maneuvering space is occupied by other vehicles. A demand trajectory can be a trajectory which better meets the desired driving goal, is therefore more favorable than the reference trajectory. The demand trajectory is subject to conflict with other trajectories. The demand trajectory can optionally be communicated.

A cost value can be transmitted for each trajectory. This enables each trajectory to be related to the other trajectories and their importance and priority to be derived therefrom. The transmission of the cost value for each trajectory permits other road users to determine a local approximation of the cost function of the transmitting vehicle. This is particularly successful if the cost values and the associated trajectories are evaluated collected over time.

The effort value describes the driving effort required to drive along one of the trajectories. The driving effort can be different for different vehicles. For example, the driving effort for an agile, light vehicle can be lower than for a large, heavy vehicle on the same trajectory. Consistent driving without velocity change and direction change can be assessed with a lower driving effort or no driving effort. Strong braking or acceleration can be assessed with a greater driving effort than weak braking or acceleration, a narrower curve radius can also be assessed with a greater driving effort than a wider curve radius. The effort value unifies the driving efforts required along the respective trajectory to form a numeric value. A trajectory having extreme driving maneuvers will thus be assessed with a higher effort value than a trajectory having weakly defined driving maneuvers. An assessment criterion can assign numeric values for the driving effort to the individual driving maneuvers. The assessment criterion can be influenced by a driver of the vehicle.

A trajectory family combines a group of possible trajectories which intersect in a common point or originate from a common point. The common point can be a current position of the vehicle at the current time. The trajectories of the trajectory family are all at least slightly different, at least one driving maneuver is different in all trajectories of the trajectory family. Different trajectories of the trajectory family can intersect. A random position can be reached here at the same future time via different trajectories.

A (trajectory) tuple consists of at least two trajectories. The trajectories of a tuple are part of different trajectory families of different vehicles. The trajectories of the tuple therefore originate from different points. The trajectories of the tuple can intersect. If the different vehicles reached the intersection of the trajectories at different times, the tuple is assessed as free of collisions if the vehicles are spaced apart from one another at all times at least by a minimum distance. The minimum distance can be greater in the direction of the trajectories than transversely to the trajectories. The minimum distance can be velocity-dependent.

A driving maneuver of a vehicle can be understood as steering, braking, and/or accelerating of the vehicle. Driving maneuvers can be velocity-dependent, for example, a current velocity of the vehicle determines a present minimum drivable curve radius.

The vehicle can also be referred to as an ego vehicle and comprises a device which carries out a method according to at least one of the embodiments described here. The vehicle can be at least partially controlled by a driver; the driving maneuvers can also be at least partially actuated by a control unit. The vehicle can also be controlled in a fully autonomous or semiautonomous manner by the control unit.

A foreign vehicle is a different vehicle. The prefix “foreign” is also used in the text for other terms assigned to the foreign vehicle for distinguishability. The foreign vehicle is controlled by a foreign driver or a foreign control unit. The method presented here can also be carried out on a foreign device of the foreign vehicle. A foreign maneuver can be understood as a driving maneuver of the foreign vehicle. The approach presented here can also be carried out with exchanged roles, from the perspective of the foreign vehicle, wherein the terms vehicle and foreign vehicle and the associated features are exchanged in this case.

The concept of the right-of-way in a traffic situation means that other vehicles are required to wait for the vehicle having right-of-way. The right-of-way is given on the basis of traffic rules, for example, the right-of-way can be given by traffic signs, traffic signals, or also by special rights (emergency vehicles with emergency lights and sirens).

A data packet can be a message which is closed per se and can be referred to as a maneuver coordination message. The data packet can be transmitted via a communication interface from the vehicle to foreign vehicles. Vice versa, the foreign vehicles can provide foreign data packets via the communication interface for the vehicle. A single item of trajectory information of a single trajectory planned ahead for the vehicle can be contained in the data packet or the foreign data packet. In particular, items of trajectory information from different trajectories of a trajectory family planned ahead for the vehicle are contained in the data packet. The trajectories can be mapped as a sequence of location coordinates at defined intervals from one another. The intervals can be spatial or chronological in this case. In the case of spatial intervals, the location coordinates are provided with timestamps. The trajectories can also be mapped in a parameterized manner. The trajectory can be mathematically described as a curve in this case. The trajectory can be described in sections. Furthermore, sensor data of the vehicle can be contained in a data packet. A present situation can be assessed in an improved manner by the sensor data, since sensor data are available from a different viewing angle than the ego viewing angle. The collision horizon can be set using the sensor data. Obstacles can be identified well, for example, by a combination of sensor data of multiple vehicles.

In one preferred embodiment, a method for cooperative coordination of driving maneuvers of an ego vehicle with foreign maneuvers of at least one foreign vehicle comprises the following steps:
generating a trajectory family, which comprises planned-ahead ego trajectories for the ego vehicle, wherein the ego trajectories comprise a reference trajectory;
receiving one or more foreign data packets from the at least one foreign vehicle, wherein a foreign trajectory family, which comprises different planned-ahead foreign trajectories for the respective foreign vehicle, is contained in a foreign data packet;
generating additional foreign trajectories which correspond to further possible driving maneuvers of a foreign vehicle;
forming tuples made up in each case of an ego trajectory and a foreign trajectory or an initial foreign trajectory and assessing the tuple using a tuple effort value;
determining collision-free tuples, wherein those tuples are selected in which the ego trajectory and the foreign trajectory are collision-free within a collision horizon;
determining whether the ego vehicle has the right-of-way and, if the ego vehicle has the right-of-way:
selecting a trajectory from the tuple having the lowest tuple effort value as an egoistic trajectory from those collision-free tuples which comprise both planned-ahead foreign trajectories and additional foreign trajectories;
selecting a trajectory from the tuple having the lowest tuple effort value as an altruistic trajectory from all collision-free tuples which only comprise planned-ahead foreign trajectories of foreign vehicles;
determining a difference between a tuple effort value of the tuple comprising the altruistic trajectory and a tuple effort value of the tuple comprising the egoistic trajectory;
selecting a trajectory, wherein the egoistic trajectory is selected if the absolute value of the determined difference is greater than a tuple effort limiting value or the altruistic trajectory is selected if the absolute value of the determined difference is less than the tuple effort limiting value or is equal to the tuple effort limiting value;
sending a data packet to the foreign vehicle, wherein depending on the result of the comparison, the data packet comprises the egoistic trajectory or the altruistic trajectory as the reference trajectory,
wherein the tuple effort limiting value is increased with progressing cooperation duration.

In this embodiment, the ego vehicle can select, based on items of information which comprise the ego reference and demand trajectories and received and (self-) generated foreign trajectories, that combination of ego and foreign trajectories which results in a reasonable cooperation between the vehicles. A tuple effort limiting value specifies in this case whether an egoistic or altruistic solution is preferred in the context of the cooperation. If the difference between the egoistic or altruistic solution is small (less than the tuple effort limiting value), the altruistic solution is taken.

In general, the introduction of such a cooperation takes place in that demand trajectories are contained in the messages exchanged by the vehicles, in this way it is clear that a running cooperation does not yet exist, because during an existing cooperation, demand trajectories are not transmitted, but rather reference trajectories.

As described, one or more—in particular correspondingly calculated—additional trajectory (trajectories) are generated by the vehicle. This can take place in particular when no foreign reference trajectory of the foreign vehicle is present. These one or more additional trajectories represent trajectories which the foreign vehicle could probably also follow in the respective situation. These can be used as the foreign reference trajectory. For example, this can be provided if no foreign reference trajectory was received from the foreign vehicle, in particular if it is not capable of V2X communication.

Furthermore, a tuple effort limiting value is used here, below which the difference of the tuple effort values of the collision-free tuple has to come so that a cooperation with a further vehicle is fundamentally accepted at all or an existing cooperation is continued. If the tuple effort limiting value is reached or exceeded, the cooperation is then terminated according to at least one embodiment and another tuple can be selected.

In other words, for the costs of a maneuver of the vehicle and foreign vehicle, a threshold is defined below which a cooperative solution has to come to be accepted. This will initially typically lie above the costs of an egoistic solution without consideration of the further vehicle. The tuple effort limiting value therefore represents a defined measure for a general readiness for cooperation while accepting ego additional costs. Since traffic situations change permanently and planned maneuvers can typically not always be implemented as planned in the course of time, deviations will possibly occur in the assessment and the cost calculation in later computing cycles. The tuple effort limiting value is therefore raised with progressing cooperation duration according to at least one embodiment, notwithstanding the fact that the difference of the tuple effort value will thus possibly likewise become greater in comparison to the optimum maneuver planning solution actually present at the respective time. The adjustment of the tuple effort limiting value can therefore be viewed as the increasing motivation to also want to guide a cooperative maneuver which has been agreed upon once to a successful conclusion. The stability of cooperative driving maneuver planning is therefore improved.

In a further embodiment, a maximum value for the tuple effort limiting value is provided, from which no further increase of the tuple effort limiting value takes place with progressing cooperation duration. The ego additional effort is therefore limited to a tolerated measure.

In a further embodiment, a counter is incremented when and as long as the altruistic trajectory is selected, wherein the cooperation duration results from the counter. In this way, even in the case that, for example, no explicit cooperation is provided according to a maneuver planning protocol used, it can nonetheless be determined whether a cooperation with a further road user exists or not. The counter can in particular be reset when an egoistic trajectory is selected. According to one aspect, the counter is only incremented when a cooperation with the same foreign vehicle exists. According to a refinement, this can be carried out by tracking and comparing the egoistic trajectory with the altruistic trajectory, wherein it is established whether the same foreign vehicle as before is to enable the foreign demand trajectory or foreign reference trajectory. An existing cooperation can thus be detected even with rapidly changing cooperation partners. The transmitter can be identified in the trajectory, the sender is thus documented and is therefore easily determinable.

In a further embodiment, the trajectory and the associated effort value of the collision-free tuple having the lowest tuple effort value is selected as the reference trajectory and the reference effort value is selected for which the tuple effort value is less than or equal to the tuple effort limiting value.

In a further embodiment, the ego trajectories comprise one or more demand trajectories.

In a further embodiment, the trajectory and the associated effort value of the collision-free tuple having the lowest tuple effort value which comprises a foreign reference trajectory and a foreign reference effort value of the foreign vehicle (100) are selected as the reference trajectory (110) and reference effort value for which the tuple effort value is less than or equal to the tuple effort limiting value.

In a further embodiment, a computer program product is configured to carry out, implement, and/or actuate the steps described in the preceding embodiments. The computer program product can be stored on a machine-readable carrier or storage medium such as a semiconductor memory, a hard drive memory, or an optical memory and can be used to carry out, implement, and/or actuate the steps of the method according to any one of the above-described embodiments, in particular when the program product or program is executed on a computer or a device.

In a further embodiment, a device comprises means which carry out, implement, and/or actuate the steps described in the preceding embodiments. The device can be an electrical device having at least one computing unit for processing signals or data, at least one storage unit for storing signals or data, and at least one interface and/or one communication interface for inputting or outputting data which are embedded in a communication protocol. The computing unit can be, for example, a signal processor, a so-called system ASIC, a microprocessor, or a microcontroller for processing sensory signals of the ego and/or foreign vehicles and outputting data signals as a function of the sensor signals. The storage unit can be, for example, a flash memory, an EPROM, or a magnetic storage unit. The interface can be designed as a sensor interface for inputting the sensor signals from a sensor and/or an actuator interface for outputting the data signals and/or control signals to an actuator. The communication interface can be designed to input or output the data in a wireless and/or wired manner. The interfaces can also be software modules which are provided, for example, on a microcontroller in addition to other software modules.

With regard to the above-discussed tuple effort limiting value, the adjustment of the tuple effort limiting value can take place with a hysteresis, wherein the hysteresis becomes larger and larger with the cooperation duration. Dynamic changes of a journey during a cooperative maneuver are therefore taken into consideration, by which it is possible to prevent a repeated termination and restart of a cooperation and therefore unclear conditions for the other vehicles around the maneuvering space from arising. The chances for success of a cooperation permitted once increase. If the cooperation is terminated, the tuple effort limiting value can then be reset. Upon a new cooperation, the tuple effort limiting value can be set to zero, alternatively also to a predetermined starting value.

It can be reasonable to perform the definition of the tuple effort limiting value depending on the vehicle. For example, the type of the vehicle can be taken into consideration, wherein the type can comprise a passenger vehicle, truck, bus, or the like. Alternatively or additionally, the velocity can also be taken into consideration in the definition of the tuple effort limiting value, or also the right-of-way/lack of right-of-way of the vehicle.

Effort values for each trajectory can be contained in the data packet. The trajectories are comparable by the effort values without having to understand a driving effort of the individual driving maneuvers for each trajectory. The individual effort values of the trajectories of a tuple can be added up, for example, to obtain the tuple effort value of the tuple. The effort values can also be weighted differently in order to determine the tuple effort value. In the weighting of the effort values, a cooperation readiness of the drivers of the observed vehicles can be taken into consideration.

A function-specific component can also be incorporated in the tuple effort value. A function-specific component can be, for example, a comfort condition which has the result that in particular tuples having noncritical vehicle distances are preferred.

At least one further foreign data packet can be received from a further foreign vehicle. A further foreign trajectory can be added to the tuple. The tuple effort value can be supplemented with a further foreign effort value. The tuple can be formed from three or more trajectories.

As described, in the approach presented here, a decentralized coordination of cooperative driving maneuvers based on optional trajectories is presented. A method for a cooperative maneuver coordination is described which is based on the exchange of trajectories. Items of information about the currently planned trajectory or reference trajectory and possible trajectories, for example, for an evasion maneuver (alternative trajectories) or for an intended maneuver (demand trajectories) are transmitted here with associated effort assessments. The participating vehicles can thus coordinate an optimum common maneuver (having the least total effort). Only precisely one single desired trajectory is not always transmitted in this case, which expands the room for negotiation in complex scenarios and increases the probability of a cooperation profitable for all sides. The decision as to whether a demand trajectory is enabled does not take place on the basis of a global cost function, which relates to assumptions for the costs of other vehicles. For optimum decision making, a cost function which is identical among all vehicle producers is not required or an error-susceptible assumption can be omitted. The intrinsic costs are internally calculated in each vehicle and can be transmitted to the other vehicles scaled to the interval [−1, 1].

In the approach presented here, cooperation does not require an active request. The cooperation can be offered here by a vehicle which already recognizes the future need for cooperation beforehand by another, for example, because it has a much more comprehensive surroundings model thanks to its better sensor system, by means of alternative trajectories.

Furthermore, a negotiation or optimized coordination of maneuvers is possible. For example, the first vehicle could send a demand trajectory which requires the second vehicle to reduce the velocity by 20 km/h, if the second vehicle wishes to cooperate. In the approach presented here, the second vehicle can communicate, for example, by sending a corresponding alternative trajectory, that a reduction of the velocity by 10 km/h would be acceptable and it would then be ready for cooperation. A specific change of the reference trajectory is not necessary in this case, due to which an immediate intervention in the vehicle control can be avoided. Nonbinding progressive negotiation/optimization is thus achieved.

In the approach presented here, nonbinding sending of trajectories takes place. The decentralized cooperative maneuver coordination has two parts. On the one hand, a protocol having a set of rules is presented which permits vehicles to communicate. On the other hand, methods are presented to carry out different cooperative maneuver coordinations with the aid of this protocol. The fundamental principle is that vehicles exchange trajectories. The vehicle can thus communicate trajectories preventively/proactively which it would be ready to drive since the disadvantages are acceptable in the scope of its own cost function. There is the possibility of negotiating about a cooperation before influence is taken on the respective vehicle. The possibility results therefrom of efficient optimization of the maneuvers of the vehicles participating in a cooperation. Furthermore, the possibility results of extremely reducing the need for computing, since preferences of all cooperation partners are coded and communicated explicitly via effort values or costs and therefore a more complex cost analysis for foreign vehicles can be omitted. The chance for a successful cooperation increases due to the transmitted cost value, since the costs of the cooperation partner can be better estimated, a local estimation of foreign costs can possibly even be omitted entirely. The costs for one of the received foreign trajectories can also be estimated locally in the vehicle. If necessary, the received cost values of all foreign costs can be scaled. Therefore, rough comparability of the ego and foreign costs can be enabled with low computing effort. Better assistance of maneuver planning algorithms results due to the introduction of categories.

To now represent a stable cooperative maneuver, a threshold is defined for the costs of a maneuver below which a cooperative solution has to come to be accepted. This will initially be above the costs of the egoistic solution by a factor or offset. It represents a measure of a general readiness for cooperation while accepting ego additional costs. Since situations can now slightly change permanently and plans can never be implemented perfectly, deviations will occur in the assessment and the cost calculation in later computing cycles. In particular, the costs can rise above the cooperation threshold again. Therefore, this cooperation threshold is raised with progressing cooperation duration according to at least one embodiment, even if the difference from the best result thus also becomes greater. The raising maps the increasing motivation to also guide a granted cooperation to a successful conclusion in this case. At the same time, it can expediently be provided that this is to be restricted insofar as the ego demand is not completely lost sight of. One possibility could also be that the threshold is equipped with a hysteresis, wherein the hysteresis becomes greater and greater with the cooperation duration. In this way, dynamic changes of a journey during a cooperative maneuver can be taken into consideration. Continuously terminating and restarting a cooperation and therefore unclear conditions for the other vehicles in the area of the maneuvering space can thus be avoided. The chances for success of a cooperation permitted once increase.

Embodiments are described hereinafter with reference to the appended drawings, wherein neither the drawings nor the description are to be interpreted as restricting the scope of the invention. The figures are only schematic and not to scale. Identical reference signs designate identical or identically-acting features in the FIGURES.

When maneuvers are coordinated between vehicles so that, among other things, comfort, efficiency, and safety are enhanced, this can be referred to as cooperative driving. This is promoted by the possibility of direct vehicle-to-vehicle communication (V2V) and by the increasing automation of vehicles. The maneuver coordination can also take place in general situations in road traffic. Vehicles can if needed transmit items of information on their current driving behavior and their intended driving behavior in the form of a trajectory. A further vehicle checks whether it can enable the intended maneuver of the transmitting vehicle and possibly explicitly or implicitly acknowledges that by adapting its reference trajectory, so that the vehicle which has sent its intended driving maneuver can carry it out.

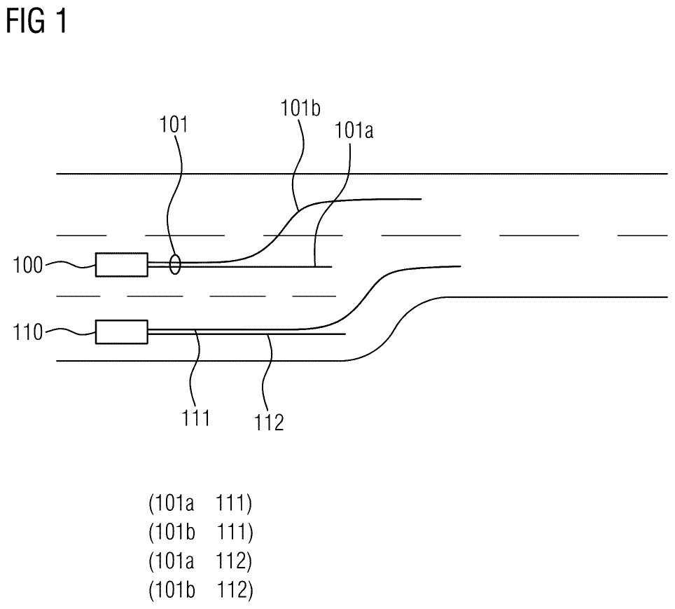

FIG. 1 shows a representation of a vehicle 100, which comprises a device (not shown) for the cooperative coordination of driving maneuvers with at least one other vehicle 110. The vehicle 100 is driving on a road in the area of an on-ramp having acceleration lane. The other vehicle 110 is located on the acceleration lane and intends to drive onto the road. The other vehicle 110 can also be referred to as a foreign vehicle. Sensors comprised by the vehicle 100 detect the current traffic situation in the surroundings of the vehicle 100, alternatively or additionally, the vehicle 100 can receive items of information about the traffic situation via wireless communication pathways, for example, in the form of V2X messages.

Presently possible trajectories are planned for the vehicle 100 depending on the traffic situation and combined to form a trajectory family 101. As described in detail above, a trajectory describes the precalculated movement of the vehicle and therefore specifies at which location the vehicle 100 will be in future if it follows this trajectory by way of driving maneuvers such as steering, braking, or accelerating.

For reasons of clarity, the trajectory family 101 only comprises two trajectories, namely the trajectories 101a and 101b. It is apparent that the number of trajectories is not restricted to two. The trajectories have the same origin, this origin is located at the current position of the vehicle 100. Depending on how the vehicle 100 will be accelerated, the trajectories are of different lengths and end at different locations. In this case, the trajectory 101a is a simple trajectory which essentially only consists of a forward movement. Trajectory 101b comprises a lane change and describes a procedure in which vehicle 100 makes space for the vehicle 110, so that it can change from the acceleration lane onto the road without having to accelerate or brake.

The vehicle 110 drives on the acceleration lane, the planned trajectory 111 of the vehicle 110 describes the acceleration of the vehicle 110 together with the lane change from the acceleration lane onto the road on which the vehicle 100 is located. The vehicle 110 sends a data packet having the planned trajectory 111 to the vehicle 100. It is apparent that the vehicle 110 can also have more than one planned trajectory, for reasons of simplicity, it is assumed that in this case only a single trajectory is planned.

The vehicle 100 receives the data packet from vehicle 110, for reasons of clarity the data packet is not shown in FIG. 1. The foreign trajectories of the vehicle 110 can be taken from the data packet. In a next step, the vehicle 101 generates one or more additional foreign trajectories, each of which describes a possible driving maneuver of the vehicle 110. In this case, trajectory 112 is generated, this trajectory describes a simple straight ahead drive with braking at the end of the acceleration lane. The vehicle 110 would thus brake on the acceleration lane so that the vehicle 100 can drive past and the vehicle 110 can drive onto the road when the vehicle 100 has passed the area of the acceleration lane. As already described above, this/these generated additional foreign trajectory (trajectories) is/are driving maneuvers which are not planned by the vehicle 110, but can be relevant for the maneuver planning of the vehicle 100, and are therefore assumed thereby as hypothetical or conceivable driving maneuvers.

Based on the ego planned trajectories 101a and 101b and the received trajectory 111 and the generated trajectory 112, the vehicle 100 forms trajectory tuples, each of which comprises an ego trajectory and a foreign trajectory. In the present example, 4 tuples can therefore be generated, namely the tuple A: (101a 111), B: (101b 111), C: (101a 112), and D: (101b 112), as shown in the lower area of FIG. 1. For each tuple, a tuple effort value is determined.

Tuple A corresponds to the situation that the vehicle 100 continues to drive straight ahead, while the vehicle 110 completes a lane change. The effort value is low here, because no steering movement and possibly a minor acceleration/deceleration are necessary for the vehicle 100.

Tuple B corresponds to the situation that the vehicle 100 performs a lane change, and that the foreign vehicle also performs a lane change. The effort value is also low here, but is somewhat greater than for tuple A, because a steering movement and possibly a minor acceleration/deceleration are necessary for the vehicle 100.

Tuple C corresponds to the situation that the vehicle 100 still drives straight ahead and that the foreign vehicle drives straight ahead on the acceleration lane and brakes at the end of the acceleration lane. The effort value is also low here because no steering movement is necessary for the vehicle 100 and also no acceleration/deceleration is to be expected. In comparison to tuple A, the effort value of tuple C is less, because smaller distances occur between the vehicles in tuple A than in tuple C.

Tuple D corresponds to the situation that the vehicle 100 performs a lane change and that the foreign vehicle drives straight ahead on the acceleration lane and brakes at the end of the acceleration lane. The effort value is comparable here to that of tuple B.

For reasons of illustration, but in no way restrictively, the following tuple effort values are assumed: A: 0.2 B: 0.25 C: 0.16 D: 0.25.

The check for freedom from collision has the result that all tuples are collision-free. A consideration of right of way has the result that the vehicle 100 has the right-of-way over the vehicle 110, thus is authorized to have the right-of-way.

The egoistic or altruistic trajectory is selected from the tuple having the lowest tuple effort value. The selection of the egoistic trajectory can take place from the tuples A-D, since these comprise preplanned foreign trajectories and additional foreign trajectories, the selection of the altruistic trajectory can take place from the tuples A and B, since these only comprise preplanned foreign trajectories and no additional foreign trajectories. Therefore, the result is that the egoistic trajectory is selected from tuple C and the altruistic trajectory is selected from tuple A.

The difference of the tuple effort values is 0.4 in this example, the comparison with a tuple effort limiting value, which is assumed to be 0.5 here, has the result that the altruistic trajectory is sent to the foreign vehicle 110. Since the tuple effort limiting value is progressively increased, the selection of the egoistic trajectory would possibly have occurred if the cooperation had existed for a shorter time, since then the tuple effort limiting value would have a lower value of, for example, 0.3.

As long as the altruistic trajectory and not the egoistic trajectory is sent and followed, a cooperation exists between the vehicles 100, 110.

Although only two vehicles are shown in the example described in FIG. 1, the concept presented here can be expanded to three or more vehicles.

The described method can be implemented, for example, in software or hardware or in a mixed form made up of software and hardware, for example, in a control unit.

It is to be noted that terms such as “including”, “comprising”, etc. do not exclude other elements or steps and terms such as “a” or “one” do not exclude a plurality. Reference signs in the claims are not to be viewed as a restriction.

1. A method for cooperatively coordinating driving maneuvers of an ego vehicle with foreign maneuvers of at least one foreign vehicle, the method comprising:
generating a trajectory family, which comprises multiple planned-ahead ego trajectories for the ego vehicle, wherein the ego trajectories comprise a reference trajectory;
receiving one or more foreign data packets from the at least one foreign vehicle, wherein a foreign trajectory family, which comprises different planned-ahead foreign trajectories for the respective foreign vehicle, is contained in a foreign data packet;
generating additional foreign trajectories which correspond to further possible driving maneuvers of a foreign vehicle;
forming tuples made up in each case of an ego trajectory and a foreign trajectory or an initial foreign trajectory and assessing the tuple using a tuple effort value;
determining collision-free tuples, wherein those tuples are selected in which the ego trajectory and the foreign trajectory are collision-free within a collision horizon;
determining whether the ego vehicle has a right-of-way and, if the ego vehicle has the right-of-way:
selecting a trajectory from the tuple having the lowest tuple effort value as an egoistic trajectory from those collision-free tuples which comprise both planned-ahead foreign trajectories and additional foreign trajectories;
selecting a trajectory from the tuple having the lowest tuple effort value as an altruistic trajectory from all collision-free tuples which only comprise planned-ahead foreign trajectories of foreign vehicles;
determining a difference between a tuple effort value of the tuple comprising the altruistic trajectory and a tuple effort value of the tuple comprising the egoistic trajectory;
selecting a trajectory, wherein the egoistic trajectory is selected if the absolute value of the determined difference is greater than a tuple effort limiting value or the altruistic trajectory is selected if the absolute value of the determined difference is less than the tuple effort limiting value or is equal to the tuple effort limiting value; and
sending a data packet to the foreign vehicle, wherein depending on a result of the trajectory selection, the data packet comprises the egoistic trajectory or the altruistic trajectory as the reference trajectory,
wherein the tuple effort limiting value is increased with progressing cooperation duration.

2. The method as claimed in claim 1, wherein a maximum value is provided for the tuple effort limiting value, from which no further increase of the tuple effort limiting value takes place with progressing cooperation duration.

3. The method as claimed in claim 2, wherein a counter is incremented when and as long as the altruistic trajectory is selected, wherein the cooperation duration results from the counter.

4. The method as claimed in claim 1, wherein a counter is incremented when and as long as the altruistic trajectory is selected, wherein the cooperation duration results from the counter.

5. The method as claimed in claim 1, wherein the ego trajectories furthermore comprise one or more demand trajectories.

6. The method as claimed in claim 1, wherein the trajectory and an associated effort value of the collision-free tuple with the lowest tuple effort value is selected as the reference trajectory and reference effort value, in which the tuple effort value is less than or equal to the tuple effort limiting value.

7. The method as claimed in claim 1, wherein the trajectory and an associated effort value of the collision-free tuple having the lowest tuple effort value, which comprises a foreign reference trajectory and a foreign reference effort value of the foreign vehicle, is selected as the reference trajectory and reference effort value, in which the tuple effort value is less than or equal to the tuple effort limiting value.

8. A non-transitory computer readable storage medium having data stored therein representing software executable by a computer, the software including instructions, which, when executed by the computer, carry out, implement, or actuate the method as claimed in claim 1.

9. The non-transitory computer readable storage medium according to claim 8, wherein wherein a maximum value is provided for the tuple effort limiting value, from which no further increase of the tuple effort limiting value takes place with progressing cooperation duration.

10. The non-transitory computer readable storage medium according to claim 8, wherein a counter is incremented when and as long as the altruistic trajectory is selected, wherein the cooperation duration results from the counter.

11. The non-transitory computer readable storage medium according to claim 8, wherein the ego trajectories furthermore comprise one or more demand trajectories.

12. The non-transitory computer readable storage medium according to claim 8, wherein the trajectory and an associated effort value of the collision-free tuple with the lowest tuple effort value is selected as the reference trajectory and reference effort value, in which the tuple effort value is less than or equal to the tuple effort limiting value.

13. The non-transitory computer readable storage medium according to claim 8, wherein the trajectory and an associated effort value of the collision-free tuple having the lowest tuple effort value, which comprises a foreign reference trajectory and a foreign reference effort value of the foreign vehicle, is selected as the reference trajectory and reference effort value, in which the tuple effort value is less than or equal to the tuple effort limiting value.

14. A device comprising means configured to carry out, implement, and/or actuate a method as claimed in claim 1.

15. The device according to claim 14, wherein a maximum value is provided for the tuple effort limiting value, from which no further increase of the tuple effort limiting value takes place with progressing cooperation duration.

16. The device according to claim 15, wherein a counter is incremented when and as long as the altruistic trajectory is selected, wherein the cooperation duration results from the counter.

17. The device according to claim 14, wherein a counter is incremented when and as long as the altruistic trajectory is selected, wherein the cooperation duration results from the counter.

18. The device according to claim 14, wherein the ego trajectories furthermore comprise one or more demand trajectories.

19. The device according to claim 14, wherein the trajectory and an associated effort value of the collision-free tuple with the lowest tuple effort value is selected as the reference trajectory and reference effort value, in which the tuple effort value is less than or equal to the tuple effort limiting value.

20. The device according to claim 14, wherein the trajectory and an associated effort value of the collision-free tuple having the lowest tuple effort value, which comprises a foreign reference trajectory and a foreign reference effort value of the foreign vehicle, is selected as the reference trajectory and reference effort value, in which the tuple effort value is less than or equal to the tuple effort limiting value.
